(19) United States
(12) Patent Application Publication
(10) Pub. No.: US 2025/0123908 A1
(43) Pub. Date: Apr. 17, 2025

(54) METHOD AND APPARATUS FOR DATA SHARING

(71) Applicant: BOE Technology Group Co., Ltd., Beijing (CN)

(72) Inventor: Dongbo Cao, Beijing (CN)

(73) Assignee: BOE Technology Group Co., Ltd., Beijing (CN)

(21) Appl. No.: 18/686,534

(22) PCT Filed: Jul. 29, 2022
(86) PCT No.: PCT/CN2022/109186

§ 371 Date: Feb. 26, 2024

(51) Int. Cl. G06F 9/54; G06F 3/16; G06F 9/30; G06F 13/28; G06F 21/16

(52) U.S. Cl. CPC G06F 9/544; G06F 9/30101; G06F 13/28; G06F 3/16; G06F 21/16

(57) ABSTRACT

A method and apparatus for data sharing. which are used for improving the usage efficiency of audio data and avoiding frame loss and lagging of a piece of audio. The method includes: acquiring target audio data to be shared between different application programs, and storing the target audio data in a memory; determining a file descriptor corresponding to the target audio data according to a memory address where the target audio data is stored; and sharing the file descriptor between the different application programs, so that the different application programs acquire the target audio data according to the memory address corresponding to the file descriptor.

### TECHNICAL FIELD

The present disclosure relates to the technical field of data processing, in particular to a method and an apparatus for data sharing.

### BACKGROUND

An audio processing logic of a traditional Android core is mainly realized with an audio core framework, which provides various interfaces for APPs at an upper level, and the APPs at the upper level can realize functions such as recording, editing and playing by calling the interfaces provided by the audio core framework.

When App1 and App2 need to share audio data, since processes of different APPs cannot be accessed by each other, if a process of one APP is to access the audio data of a process of another APP, the audio data needs to be copied once before it is processed or played. However, a current mode of copying the audio data greatly reduces use efficiency of the audio data, and may also cause situations such as audio frame loss and lagging in special scenes.

### SUMMARY

The present disclosure provides a method and an apparatus for data sharing, which are configured for improving the use efficiency of the audio data and avoiding situations such as audio frame loss and lagging.

In a first aspect, an embodiment of the present disclosure provides a method for data sharing includes:
acquiring target audio data to be shared between different applications and storing the target audio data in a memory;
determining a file descriptor corresponding to the target audio data according to a memory address at which the target audio data is stored; and
sharing the file descriptor between the different applications, so that the different applications acquire the target audio data according to the memory address corresponding to the file descriptor.

As an alternative implementation, the acquiring target audio data to be shared between the different applications and storing the target audio data in the memory includes:
determining a hardware register of the target audio data when the different applications need to share the target audio data; and
acquiring the target audio data from the hardware register and storing the target audio data in the memory.

As an alternative implementation, the acquiring the target audio data from the hardware register and storing the target audio data in the memory comprises:
storing the target audio data in the hardware register in a physical memory by using a direct memory access mechanism.

As an alternative implementation, the storing the target audio data in the hardware register in the physical memory comprises:
allocating continuous physical memories for the target audio data by using continuous memory allocation technology; and
storing the target audio data in the allocated continuous physical memories.

As an alternative implementation, the different applications comprises a first application and a second application, the first application is configured for recording audio, and the second application is configured for adding a watermark to the audio;
the acquiring the target audio data to be shared between the different applications and storing the target audio data in the memory comprises:
acquiring recorded audio by the first application and storing the recorded audio in a hardware register; and
taking the recorded audio as the target audio data to be shared between the first application and the second application, and storing the recorded audio stored in the hardware register in a physical memory.

As an alternative implementation, the different applications comprises a third application and a fourth application, the third application is configured for playing audio containing a watermark, and the fourth application is configured for verifying the watermark in the audio containing the watermark; and
the acquiring the target audio data to be shared between the different applications and storing the target audio data in the memory comprises:
storing the played audio containing the watermark as the target audio data to be shared in a physical memory if it is determined that the fourth application is used to verify the watermark when the third application plays the audio containing the watermark; and
the method further comprises:
transferring the audio containing the watermark from the physical memory to a hardware register, so that an audio hardware reads the audio containing the watermark from the hardware register and plays the audio containing the watermark.

As an alternative implementation, the target audio data is stored in a physical memory;
the determining the file descriptor corresponding to the target audio data according to the memory address at which the target audio data is stored comprises:
respectively mapping a physical memory address at which the target audio data is stored to virtual memory addresses of the different applications, wherein the virtual memory addresses are isolated from each other between the different applications; and
establishing a mapping relationship between the virtual memory addresses of the different applications and a same file descriptor, and determining the file descriptor corresponding to the target audio data according to the mapping relationship.

As an alternative implementation, the determining the file descriptor corresponding to the target audio data according to the memory address at which the target audio data is stored comprises:
by using a kernel of an operating system, mapping the physical memory address at which the target audio data is stored to the virtual memory addresses of the different applications, establishing the mapping relationship between the virtual memory addresses of the different applications and the same file descriptor, and determining the file descriptor corresponding to the target audio data according to the mapping relationship.

As an alternative implementation, the establishing the mapping relationship between the virtual memory addresses of the different applications and the same file descriptor, and determining the file descriptor corresponding to the target audio data according to the mapping relationship comprises:
establishing the mapping relationship between the virtual memory addresses of the different applications and a same handle, and determining a handle corresponding to the target audio data according to the mapping relationship.

As an alternative implementation, the sharing the file descriptor between the different applications comprises:
mapping the virtual memory addresses of the different applications to the same handle, and sharing the handle between the different applications, so that the different applications process the target audio data corresponding to the virtual memory addresses mapped by the handle.

As an alternative implementation, the target audio data to be shared comprises target audio data processed by the different applications at the same time.

As an alternative implementation, the different applications comprise different applications running on an Android system.

As an alternative implementation, the sharing the file descriptor between the different applications comprises:
transmitting the file descriptor to the different applications using an audio framework, so that the file descriptor is shared between the different applications.

As an alternative implementation, the method further comprises:
by the different applications, acquiring the target audio data according to the memory address corresponding to the file descriptor, and processing the target audio data; and
the processing the target audio data comprises:
providing a time delay in processing of the target audio data by the different applications.

In a second aspect, an embodiment of the present disclosure provides a system for data sharing, comprising an audio driving module and an audio frame module, wherein
the audio driving module is configured to acquire target audio data to be shared between different applications and store the target audio data in a memory; and determine a file descriptor corresponding to the target audio data according to a memory address at which the target audio data is stored; and
the audio frame module is configured to share the file descriptor between the different applications, so that the different applications acquire the target audio data according to the memory address corresponding to the file descriptor.

As an alternative implementation, the audio driving module is specifically configured for:
determining a hardware register of the target audio data when the different applications need to share the target audio data; and
acquiring the target audio data from the hardware register and storing the target audio data in the memory.

As an alternative implementation, the audio driving module is specifically configured for:
storing the target audio data in the hardware register in the physical memory by using a direct memory access mechanism.

As an alternative implementation, the audio driving module is specifically configured for:
allocating continuous physical memories for the target audio data by using continuous memory allocation technology; and
storing the target audio data in the allocated continuous physical memories.

As an alternative implementation, the different applications include a first application and a second application. The first application is configured for recording audio, and the second application is configured for adding a watermark to the audio;
the audio driving module is specifically configured for:
acquiring recorded audio through the first application and storing the recorded audio in a hardware register; and
taking the recorded audio as the target audio data to be shared between the first application and the second application, and storing the recorded audio stored in the hardware register in the physical memory.

As an alternative implementation, the different applications include a third application and a fourth application. The third application is configured for playing audio containing a watermark, and the fourth application is configured for verifying the watermark in the audio containing the watermark;
the audio driving module is specifically configured for:
storing the played audio containing the watermark in the physical memory as target audio data to be shared if it is determined that the fourth application is used to verify the watermark when the third application plays the audio containing the watermark;
the audio driving module is specifically further configured for:
transferring the audio containing the watermark from the physical memory to a hardware register, so that an audio hardware reads the audio containing the watermark from the hardware register and play the audio containing the watermark.

As an alternative implementation, the target audio data is stored in the physical memory;
the audio driving module is specifically configured for:
respectively mapping the physical memory address at which the target audio data is stored to virtual memory addresses of the different applications, the virtual memory addresses being isolated from each other between the different applications; and
establishing a mapping relationship between the virtual memory addresses of the different applications and a same file descriptor, and determining the file descriptor corresponding to the target audio data according to the mapping relationship.

As an alternative implementation, the audio driving module is specifically configured for:
by using a kernel of an operating system, mapping the physical memory address at which the target audio data is stored to the virtual memory addresses of the different applications, establishing the mapping relationship between the virtual memory addresses of the different applications and the same file descriptor, and determining the file descriptor corresponding to the target audio data according to the mapping relationship.

As an alternative implementation, the audio driving module is specifically configured for:
establishing the mapping relationship between the virtual memory addresses of the different applications and the same handle, and determining a handle corresponding to the target audio data according to the mapping relationship.

As an alternative implementation, the audio frame module is specifically configured for:
mapping the virtual memory addresses of the different applications to a same handle, and sharing the handle between the different applications, so that the different applications process the target audio data corresponding to the virtual memory addresses mapped by the handle.

As an alternative implementation, the target audio data to be shared includes target audio data processed by the different applications at the same time.

As an alternative implementation, the different applications include different applications running on an Android system.

As an alternative implementation, the audio frame module is specifically configured for:
transmitting the file descriptor to the different applications using an audio framework, so that the file descriptor is shared between the different applications.

As an alternative implementation, the system further includes a delay processing module being specifically configured for:
acquiring the target audio data according to the memory address corresponding to the file descriptor and processing the target audio data by the different applications; and
the processing the target audio data includes:
providing a time delay in processing of the target audio data by the different applications.

In a third aspect, an embodiment of the present disclosure provides an apparatus for data sharing, wherein the apparatus comprises a processor and a memory, wherein the memory is configured for storing programs executable by the processor, and the processor is configured for reading the programs in the memory and executing the following steps:
acquiring target audio data to be shared between different applications and storing the target audio data in a memory;
determining a file descriptor corresponding to the target audio data according to a memory address at which the target audio data is stored; and
sharing the file descriptor between the different applications, so that the different applications acquire the target audio data according to the memory address corresponding to the file descriptor.

As an alternative implementation, the processor is specifically configured for:
determining a hardware register of the target audio data when the different applications need to share the target audio data; and
acquiring the target audio data from the hardware register and storing the target audio data in the memory.

As an alternative implementation, the processor is specifically configured for:
storing the target audio data in the hardware register in the physical memory by using a direct memory access mechanism.

As an alternative implementation, the processor is specifically configured for:
allocating continuous physical memories for the target audio data by using continuous memory allocation technology; and
storing the target audio data in the allocated continuous physical memories.

As an alternative implementation, the different applications include a first application and a second application, the first application is configured for recording audio, and the second application is configured for adding a watermark to the audio;
the processor is specifically configured for:
acquiring recorded audio through the first application and storing the recorded audio in a hardware register; and
taking the recorded audio as the target audio data to be shared between the first application and the second application, and storing the recorded audio stored in the hardware register in the physical memory.

As an alternative implementation, the different applications include a third application and a fourth application, the third application is configured for playing audio containing a watermark, and the fourth application is configured for verifying the watermark in the audio containing the watermark;
the processor is specifically configured for:
storing the played audio containing the watermark in the physical memory as target audio data to be shared if it is determined that the fourth application is used to verify the watermark when the third application plays the audio containing the watermark; and
the processor is specifically further configured for:
transferring the audio containing the watermark from the physical memory to a hardware register, so that an audio hardware reads the audio containing the watermark from the hardware register and play the audio containing the watermark.

As an alternative implementation, the target audio data is stored in the physical memory.
the processor is specifically configured for:
respectively mapping the physical memory address at which the target audio data is stored to virtual memory addresses of the different applications, the virtual memory addresses being isolated from each other between the different applications; and
establishing a mapping relationship between the virtual memory addresses of the different applications and a same file descriptor, and determining the file descriptor corresponding to the target audio data according to the mapping relationship.

As an alternative implementation, the processor is specifically configured for:
by using a kernel of an operating system, mapping the physical memory address at which the target audio data is stored to the virtual memory addresses of the different applications, establishing the mapping relationship between the virtual memory addresses of the different applications and the same file descriptor, and determining the file descriptor corresponding to the target audio data according to the mapping relationship.

As an alternative implementation, the processor is specifically configured for:
establishing the mapping relationship between the virtual memory addresses of the different applications and the same handle, and determining a handle corresponding to the target audio data according to the mapping relationship.

As an alternative implementation, the processor is specifically configured for:
mapping the virtual memory addresses of the different applications to a same handle, and sharing the handle between the different applications, so that the different applications process the target audio data corresponding to the virtual memory addresses mapped by the handle.

As an alternative implementation, the target audio data to be shared includes target audio data processed by the different applications at the same time.

As an alternative implementation, the different applications include different applications running on an Android system.

As an alternative implementation, the processor is specifically configured for:
transmitting the file descriptor to the different applications using an audio framework, so that the file descriptor is shared between the different applications.

As an alternative implementation, the processor is specifically further configured for:
acquiring the target audio data according to the memory address corresponding to the file descriptor and processing the target audio data by the different applications; and
the processor is specifically configured for:
providing a time delay in processing of the target audio data by the different applications.

In a fourth aspect, an embodiment of the present disclosure provides a device for data sharing, including:
an audio acquisition unit configured to acquire target audio data to be shared between different applications and store the target audio data in a memory;
an address mapping unit configured to determine a file descriptor corresponding to the target audio data according to a memory address at which the target audio data is stored; and
an audio sharing unit configured to share the file descriptor between the different applications, so that the different applications acquire the target audio data according to the memory address corresponding to the file descriptor.

As an alternative implementation, the audio acquisition unit is specifically configured for:
determining a hardware register of the target audio data when the different applications need to share the target audio data; and
acquiring the target audio data from the hardware register and storing the target audio data in the memory.

As an alternative implementation, the audio acquisition unit is specifically configured for:
storing the target audio data in the hardware register in the physical memory by using a direct memory access mechanism.

As an alternative implementation, the audio acquisition unit is specifically configured for:
allocating continuous physical memories for the target audio data by using continuous memory allocation technology; and
storing the target audio data in the allocated continuous physical memories.

As an alternative implementation, the different applications include a first application and a second application, the first application is configured for recording audio, and the second application is configured for adding a watermark to the audio;
the audio acquisition unit is specifically configured for:
acquiring recorded audio through the first application and storing the recorded audio in a hardware register; and
taking the recorded audio as the target audio data to be shared between the first application and the second application, and storing the recorded audio stored in the hardware register in the physical memory.

As an alternative implementation, the different applications include a third application and a fourth application, the third application is configured for playing audio containing a watermark, and the fourth application is configured for verifying the watermark in the audio containing the watermark;
the audio acquisition unit is specifically configured for:
storing the played audio containing the watermark in the physical memory as target audio data to be shared if it is determined that the fourth application is used to verify the watermark when the third application plays the audio containing the watermark; and
further includes a transferring unit, which is specifically configured for:
transferring the audio containing the watermark from the physical memory to a hardware register, so that an audio hardware reads the audio containing the watermark from the hardware register and play the audio containing the watermark.

As an alternative implementation, the target audio data is stored in the physical memory, the address mapping unit is specifically configured for:
respectively mapping the physical memory address at which the target audio data is stored to virtual memory addresses of the different applications, the virtual memory addresses being isolated from each other between the different applications; and
establishing a mapping relationship between the virtual memory addresses of the different applications and a same file descriptor, and determining the file descriptor corresponding to the target audio data according to the mapping relationship.

As an optional embodiment, the address mapping unit is specifically configured for:
by using a kernel of an operating system, mapping the physical memory address at which the target audio data is stored to the virtual memory addresses of the different applications, establishing the mapping relationship between the virtual memory addresses of the different applications and the same file descriptor, and determining the file descriptor corresponding to the target audio data according to the mapping relationship.

As an optional embodiment, the address mapping unit is specifically configured for:
establishing the mapping relationship between the virtual memory addresses of the different applications and the same handle, and determining a handle corresponding to the target audio data according to the mapping relationship.

As an optional embodiment, the audio sharing unit is specifically configured for:
mapping the virtual memory addresses of the different applications to a same handle, and sharing the handle between the different applications, so that the different applications process the target audio data corresponding to the virtual memory addresses mapped by the handle.

As an alternative implementation, the target audio data to be shared includes target audio data processed by the different applications at the same time.

As an alternative implementation, the different applications include different applications running on an Android system.

As an optional embodiment, the audio sharing unit is specifically configured for:
transmitting the file descriptor to the different applications using an audio framework, so that the file descriptor is shared between the different applications.

As an optional embodiment, the device further includes a delay processing unit, which is specifically configured for:
acquiring the target audio data according to the memory address corresponding to the file descriptor, and processing the target audio data by the different applications; and
the delay processing unit being specifically configured for:
providing a time delay in processing of the target audio data by the different applications.

In a fifth aspect, an embodiment of the present disclosure further provides a computer storage medium, having a computer program stored thereon, wherein the computer program, when executed by a processor, implements the steps as described in the first aspect.

These or other aspects of the present disclosure will be more concise and understandable in the description of the following embodiments.

### BRIEF DESCRIPTION OF THE DRAWINGS

In order to provide a clearer explanation of the technical solution in the embodiments of the present disclosure, a brief introduction will be given below to the accompanying drawings required in the description of the embodiments. It is evident that the accompanying drawings are only some embodiments of the present disclosure. For those skilled in the art, other accompanying drawings can be obtained based on these drawings without creative labor.

FIG. 1 is an audio processing frame diagram of a traditional Android system in related art;

FIG. 2 is an implementation flow chart of a method for data sharing according to an embodiment of the present disclosure;

FIG. 3 is an audio processing frame diagram according to an embodiment of the present disclosure;

FIG. 4 is an architecture diagram of sharing audio data between different processes according to an embodiment of the present disclosure;

FIG. 5 is an implementation flow chart of a method for audio data sharing according to an embodiment of the present disclosure;

FIG. 6 is an implementation flow chart of a method for audio data sharing for watermarking and recording according to an embodiment of the present disclosure;

FIG. 7 is an implementation flow chart of a method for audio data sharing for playing and verifying watermark according to an embodiment of the present disclosure;

FIG. 8 is a schematic diagram of a system for data sharing according to an embodiment of the present disclosure;

FIG. 9 is a schematic diagram of a device for data sharing according to an embodiment of the present disclosure; and

FIG. 10 is a schematic diagram of an apparatus for data sharing according to an embodiment of the present disclosure.

### DETAILED DESCRIPTION

In order to make the purpose, technical solution, and advantages of the present disclosure clearer, further detailed descriptions of the present disclosure will be provided below in conjunction with the accompanying drawings. Obviously, the embodiments of the present disclosure are only a part of the embodiments of the present disclosure, not all of them. Based on the embodiments disclosed in the present disclosure, all other embodiments obtained by persons skilled in the art without creative labor fall within the scope of protection of the present disclosure.

In the embodiment of the present disclosure, the term “and/or” describes the association relationship of the associated object, indicating that there can be three types of relationships, such as A and/or B, which can indicate the presence of A alone, the presence of A and B simultaneously, and the presence of B alone. The character “/” generally indicates that the associated object is an “or” relationship.

The application scenarios described in the embodiment of the present disclosure are intended to provide a clearer explanation of the technical solution of the embodiment of the present disclosure, and do not constitute a limitation on the technical solution provided in the embodiment of the present disclosure. It is known to those skilled in the art that with the emergence of new application scenarios, the technical solution provided in the embodiment of the present disclosure is also applicable to similar technical problems. In the description of the present disclosure herein, unless otherwise specified, “plurality of” means two or more.

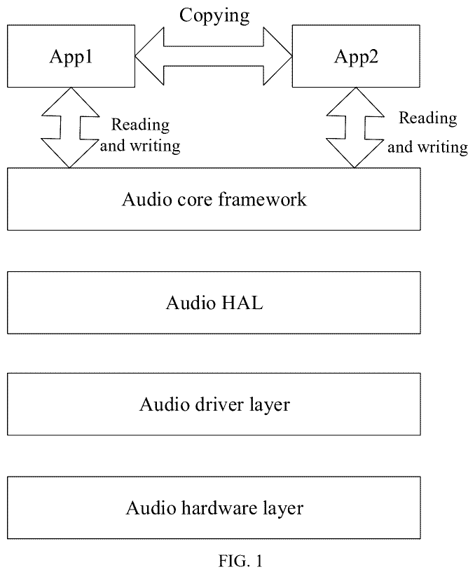

Embodiment 1. An audio processing framework of a traditional Android system is shown in FIG. 1. A lowest layer (a first layer) is an audio hardware layer (audio Codec Hardware), which is responsible for audio digital-to-analog conversion and channel management. A second layer is an audio driver layer, including a Linux ALSA audio driver framework, which is responsible for driving the audio Codec, managing a digital audio interface (DAI) and providing interfaces for character apparatus for an application layer. A third layer is audio HAL (Hardware Abstraction Layer), which shields different hardware against an upper layer (such as a fourth layer). The fourth layer is an audio core framework layer where an audio processing logic of the Android core is realized, which can provide various interfaces for upper applications APPs, and the upper applications APPs can realize functions such as recording, editing, playing by calling the interfaces provided by the Framework. When App1 and App2 need to share audio data, since processes of different APPs cannot be accessed by each other, if a process of one APP is to access the audio data of a process of another APP, the audio data needs to be copied once before it is processed or played. However, a current mode of copying audio data greatly reduces use efficiency of the audio data, and may also cause audio frame loss, lagging and other situations in special scenes. For example, when App1 needs to record the audio data C and APP2 needs to add a watermark to the audio data C, at present, each APP needs to copy the audio data once when using the audio data C, and the audio data can only be processed after copying it twice in total, which results in reduction in use efficiency of the audio data.

In order to improve the use efficiency of the audio data and avoid situations such as audio frame loss and lagging, a method for data sharing is provided in this embodiment, which can access and process audio data with no copying of the audio data, thus effectively improving the use efficiency of the audio data. A core idea of this embodiment is to store the audio data in a memory, and then share a file descriptor among a plurality of applications after the file descriptor is determined according to a memory address. When the plurality of applications need to share (use) an audio data, a file descriptor of the audio data can be shared among the plurality of applications, that is, the file descriptor of the audio data can be transmitted among the plurality of applications, and the applications can read the audio data from the memory address after a memory address is determined according to the file descriptor, thus performing audio data processing. In this embodiment, the memory address of the audio data is mapped into the file descriptor, and the file descriptor is shared between different applications, so that the audio data can be shared between different applications.

It should be noted that the method for data sharing in this embodiment can also be applied to other types of data other than audio data, and methods for data sharing based on the principle of this embodiment fall within the protection scope of the present disclosure.

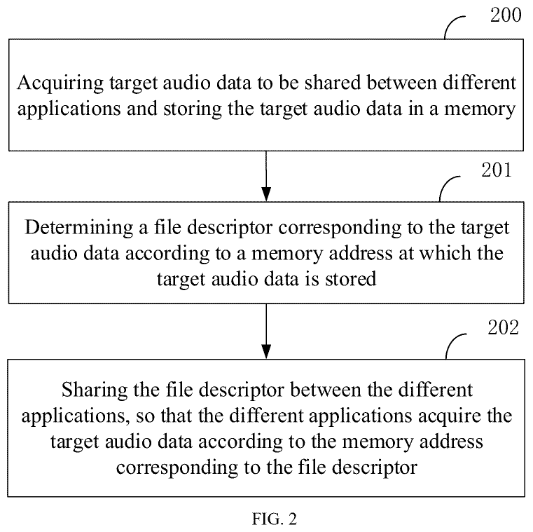

As shown in FIG. 2, a method for data sharing according to this embodiment can be applied to an Android system, and a specific implementation flow of this method is as follows.

In step 200, target audio data to be shared between different applications is acquired and the target audio data is stored in a memory.

In some embodiments, the target audio data to be shared between the different applications may be target audio data processed simultaneously between different applications. It should be noted that the simultaneous processing herein includes, but is not limited to, processing that is completely aligned in time, or processing that is not completely aligned in time, that is, there may be a certain delay in corresponding processing time in terms of two different applications.

As an alternative implementation, the different applications in this embodiment acquire the target audio data according to the memory address corresponding to the file descriptor, and process the target audio data. There may be a time delay in processing of the target audio data by the different applications.

In some embodiments, the different applications in this embodiment include different applications running on an Android system.

In some embodiments, the target audio data to be shared between the different applications is obtained and the target audio data is stored in the memory by following steps:
determining a hardware register of the target audio data when the different applications need to share the target audio data, and acquiring the target audio data from the hardware register and the target audio data is stored in the memory.

In an implementation, the audio data is stored in a corresponding hardware register. When it is determined that different applications need to share the target audio data, the target audio data is read from the hardware register corresponding to the target audio data and stored in the memory.

The hardware register in this embodiment can be a hardware register in the hardware interface controller, for storing and caching the target audio data. Any VXI bus device, regardless of its function, must have a set of configuration registers. The system can identify a type, a model, a manufacturer, an address space and a required memory space of the device by accessing the configuration registers for a PI port on a VME bus. A VXI bus device with such lowest communication ability is a register-based device. With this set of common configuration registers, a central resource manager and basic software modules, the system and the memory can be automatically configured during system initialization.

In some embodiments, the target audio data is acquired from the hardware register and the target audio data is stored in the memory in this embodiment by following steps:
storing the target audio data in the hardware register in the physical memory by using a direct memory access mechanism.

In an implementation, when it is determined that different applications need to share the target audio data, the target audio data in the hardware register corresponding to the target audio data is read in the physical memory by using the direct memory access mechanism.

It should be noted that the direct memory access mechanism includes but is not limited to a DMA (Direct Memory Access) mechanism, which can directly access data from the physical memory without via a CPU. In a DMA mode, the CPU only needs to give instructions to a DMA controller to cause the DMA controller to handle data transfer, and then feed back information to the CPU after the data transfer is completed, thus greatly reducing CPU resource occupation and effectively saving system resources.

In some embodiments, the target audio data in the hardware register is stored in the physical memory by following steps:
allocating continuous physical memories for the target audio data by using continuous memory allocation technology; and storing the target audio data in the allocated continuous physical memories.

In an implementation, the continuous memory allocation technology includes, but is not limited to, CMA (Contiguous memory allocator) with an operation principle to reserve some physical memories for the driver. However, when the driver is not in use, the memory allocator or buddy system can allocate these physical memories to a user process as an anonymous memory or page cache. When the driver needs to use it, the physical memories occupied by the process is reserved for use by the driver through recycling or migration.

Because the continuous physical memories can be allocated by using the continuous memory allocation technology, storage of the audio data is ensured to be continuous, and when the file descriptor of target audio data is shared, the complete target audio data can be read according to the file descriptor.

If it is determined that a second application is used to add a watermark to a recorded audio when a first application records audio, the recorded audio is stored in a physical memory as target audio data to be shared.

The audio containing the watermark can also be transferred from the physical memory to a hardware register, so that an audio hardware can read the audio containing the watermark from the hardware register and play it.

In some embodiments, the different applications include a first application and a second application. The first application is configured for recording audio, and the second application is configured for adding a watermark to the audio. The recorded audio is acquired by the first application and is stored in a hardware register. The recorded audio is taken as the target audio data to be shared between the first application and the second application, and the recorded audio stored in the hardware register is stored in the physical memory. Meanwhile, the recorded audio is read from the physical memory and is watermarked through the second application.

In an implementation, after the recorded audio signal is received by a microphone, the audio signal is subjected to analog-to-digital conversion, encoding and decoding processing and the like by an audio hardware layer (audio Codec Hardware), and then the target audio data is output; the target audio data is cached by a hardware register in a hardware interface controller, and the target audio data is read from the hardware register by a SoC and stored in a physical memory. The physical memory address at which the target audio data is stored is mapped to virtual memory addresses of the first application and the second application, respectively, by using a kernel of an operating system. At this time, the target audio data can be stored in a ring buffer corresponding to the virtual memory address, and a mapping relationship between the virtual memory addresses of the first application and the second application and a same file descriptor can be established, and the file descriptor corresponding to the target audio data can be determined according to the mapping relationship. When it is determined that the second application is used to add a watermark to the recorded audio when the first application records audio, the first application acquires the file descriptor corresponding to the target audio data by using the audio framework, and continues to recording the target audio data in the ring buffer corresponding to the virtual memory address according to the mapping relationship between the file descriptor and the virtual memory address of the first application. Meanwhile, the second application also acquires the file descriptor corresponding to the target audio data by using the audio framework, and continues to adding the watermark to the target audio data in the ring buffer corresponding to the virtual memory address according to the mapping relationship between the file descriptor and the virtual memory address of the second application.

In some embodiments, the different applications include a third application and a fourth application. The third application is configured for playing audio containing a watermark, and the fourth application is configured for verifying the watermark in the audio containing the watermark;
if it is determined that the fourth application is used to verify the watermark when the third application plays the audio containing the watermark, the played audio containing the watermark is stored in the physical memory as target audio data to be shared. The audio containing the watermark can also be transferred from the physical memory to a hardware register, so that an audio hardware can read the audio containing the watermark from the hardware register and play it.

In an implementation, when the audio containing watermark is played by the third application, the third application reads the audio containing the watermark from the ring buffer corresponding to the virtual memory address and plays it, determines the mapped physical memory according to the virtual memory address of the audio containing the watermark in the third application, stores the audio containing the watermark in the physical memory, caches it through the hardware register in the hardware interface controller, which is then output to the audio hardware layer for analog-to-digital conversion, and output to a loudspeaker for playing after encoding and decoding processing. Meanwhile, when it is determined that the fourth application is used to verify the watermark when the third application plays the audio containing the watermark, the physical memory address at which the target audio data is stored is mapped to virtual memory addresses of the third application and the fourth application, respectively, by using the kernel of the operating system, and a mapping relationship between the virtual memory addresses of the third application and the fourth application and a same file descriptor is established, the played audio containing the watermark is taken as target audio data, a file descriptor corresponding to the target audio data is determined according to the mapping relationship, and when it is determined that the fourth application is used to add a watermark to the recorded audio when the third application records audio, the third application acquires the file descriptor corresponding to the target audio data by using the audio framework, and continue to playing the target audio data in the ring buffer corresponding to the virtual memory address according to the mapping relationship between the file descriptor and the virtual memory address of the third application; meanwhile, the fourth application also acquires the file descriptor corresponding to the target audio data by using the audio framework, and performs watermark verification on the target audio data in the ring buffer corresponding to the virtual memory address according to the mapping relationship between the file descriptor and the virtual memory address of the fourth application, so as to verify legitimacy of the watermark.

The first application and the third application in this embodiment may be a same application or different applications, and the second application and the fourth application in this embodiment may be a same application or different applications, which is not limited in this embodiment.

In Step 201, a file descriptor corresponding to the target audio data is determined according to a memory address at which the target audio data is stored.

In some embodiments, by using a kernel of an operating system, the physical memory address at which the target audio data is stored is mapped to the virtual memory addresses of the different applications, the mapping relationship between the virtual memory addresses of the different applications and the same file descriptor is established, and the file descriptor corresponding to the target audio data is determined according to the mapping relationship.

It should be noted that when the APP is started, a size of a virtual memory allocated for the APP is fixed, that is, a size of an available virtual memory of the APP is fixed. In a process of running the APP, an actual size of the virtual memory is determined according to an actual situation of process running.

The physical memory of the system is divided into many parts with a same size, also called memory pages. A size of a memory page depends on architecture of the CPU and configuration of the operating system. Use of the physical memory is mainly divided into one or more situations of the following:

### (1) Usage of the Kernel

When the operating system starts, compressed kernel files located in a/boot directory may be loaded into the physical memory and is decompressed. This part of content always resides at a start position of the memory during permission by the system.

### (2) Usage of the Slab Distributor

More space is needed in running of the operating system to be allocated to the management process, file descriptors, socket, loaded kernel modules and the like. Thus, the kernel may dynamically allocate the physical memory through the slab allocator.

### (3) Usage of the Process

Except a part used by the kernel, all processes need physical memory pages to be allocated to their code, data and stacks. These physical memories consumed by the processes are called “resident memory”, RSS.

### (4) Usage of the Page Cache

Except the part used in the kernel and processes, rest of the physical memory is called

page cache. Because a speed of a disk IO is much lower than an access speed of the memory, the page cache stores data read from a disk as much as possible in order to speed up a speed of accessing disk data. There is also a part of the page cache called a buffer, which is used to buffer data to be written to the disk.

The virtual memory does not actually exist, and just exists in this ingenious memory management mechanism. When a process starts, the kernel may create a virtual address space for a new process. This virtual address space represents all of the memory that the process may use, certainly, it can be dynamically changed. A schematic diagram of a virtual address structure is as follows. The address increases from bottom to top, mainly including following parts:
(1) a code segment, which is read-only and configured to store loaded code.
(2) A data segment, which is configured to store global variables and static variables.
(3) A heap, which is a dynamic memory. When a memory released by a malloc/free application is less than a certain threshold, a top pointer of the heap is controlled to shift to a high address (malloc) or a low address (free) through calling by a brk/sbrk system.
(4) A file mapping area, which is a dynamic memory. When the memory released by the malloc/free application are larger than 128 K, a virtual address space is allocated through calling by a mmap system.
(5) A stack, which is configured to store local variables and process context.

Due to limitation of cost, the physical memory cannot be made large, but a memory required to apply for in a process running stage may far exceed the physical memory, and the system cannot run only one process, and there may be a plurality of processes applying for the memory together. If they all apply for the physical memory directly, this definitely cannot be satisfied. By introducing the virtual memory, each process has its own independent virtual address space, which can be infinite in theory. It is impossible for a process to access all of variable data at the same time, and when some data is accessed, it is only necessary to map this virtual memory to the physical memory, and other virtual address spaces that have not been actually accessed may not occupy the physical memory, thus greatly reducing consumption of the physical memory. The system kernel maintains a mapping table from the virtual memory to the physical memory for each process, which is also called a page table. A mapped physical page position and offset of data in the physical page can be searched in the page table according to the virtual address, so as to get a physical address that needs to be accessed actually.

In some embodiments, after the target audio data is determined, the target audio data can be firstly stored in the physical memory, the physical memory is mapped to virtual memories of the different applications, and virtual memory addresses of the different applications are mapped to a same file descriptor. Specific implementation steps are as follows:
(1) the physical memory address at which the target audio data is stored is respectively mapped to virtual memory addresses of the different applications. The virtual memory addresses are isolated from each other between the different applications.

In some embodiments, the virtual memory address is determined by: respectively mapping the physical memory address at which the target audio data is

stored to the virtual memory addresses of the different applications according to a pre-established mapping relationship between physical memory addresses and virtual memory addresses.

In an implementation, because the virtual memory addresses are isolated from each other between the different applications and the virtual memory addresses cannot be directly transferred between the different applications, they needs to be transferred between different applications after being converted into file descriptors through following steps.
(2) A mapping relationship between the virtual memory addresses of the different applications and a same file descriptor is established, and the file descriptor corresponding to the target audio data is determined according to the mapping relationship.

The file descriptor in this embodiment is a non-negative integer in form. In fact, it is an index value, pointing to a record table of open files of each process maintained the by the kernel for process. When an existing file is opened or a new file is created by a program, the kernel returns a file descriptor to the process. The kernel uses the file descriptor to access files. The file descriptor is a non-negative integer. When the existing file is opened or the new file is created, the kernel may return the file descriptor. The file descriptor is also required to be used to specify files to be read and written in reading and writing files.

Optionally, the file descriptor in this embodiment includes but is not limited to a handle. The handle is an identifier to identify an object or an item, which can be used to describe a form, a file, etc. The handle is set according to a problem of the memory management mechanism, that is, a problem of the virtual address. If a data address needs to be changed, it is necessary to record and manage this change after changing, so the change of the data address is recorded by the handle. In programming, the handle is a special smart pointer. When an application is to refer to memory blocks or objects managed by other systems (such as databases and operating systems), the handle can be used.

In some embodiments, the mapping relationship between the virtual memory addresses of the different applications and the same handle is established, and a handle corresponding to the target audio data is determined according to the mapping relationship.

In an implementation, virtual memory addresses of the different applications can be mapped to the same handle according to the mapping relationship between the virtual memory addresses and the handle in an IDR table.

In some embodiments, the file descriptors are shared between the different applications by:
mapping the virtual memory addresses of the different applications to the same file descriptor, and sharing the file descriptor between different applications, so that the different applications can process the target audio data corresponding to the virtual memory addresses mapped by the file descriptor.

In Step 202, the file descriptor is shared in the different applications, so that the different applications acquire the target audio data according to the memory address corresponding to the file descriptor.

In some embodiments, the file descriptor is transmitted to the different applications using an audio framework, so that the file descriptor is shared between the different applications.

In an implementation, the handle corresponding to the audio data can be transferred between the different applications, each application acquires the handle and convert the handle into the virtual memory address of the application, so that the audio data can be accessed according to the physical memory address mapped by the virtual memory address, thus realizing a purpose of accessing related audio data without copying the audio data. In this way, transfer efficiency of the audio data between Apps can be effectively improved, and problems of audio frame loss and lagging are effectively solved, and a problem can be well positioned in different audio processing stages, at different processing levels and in different Apps.

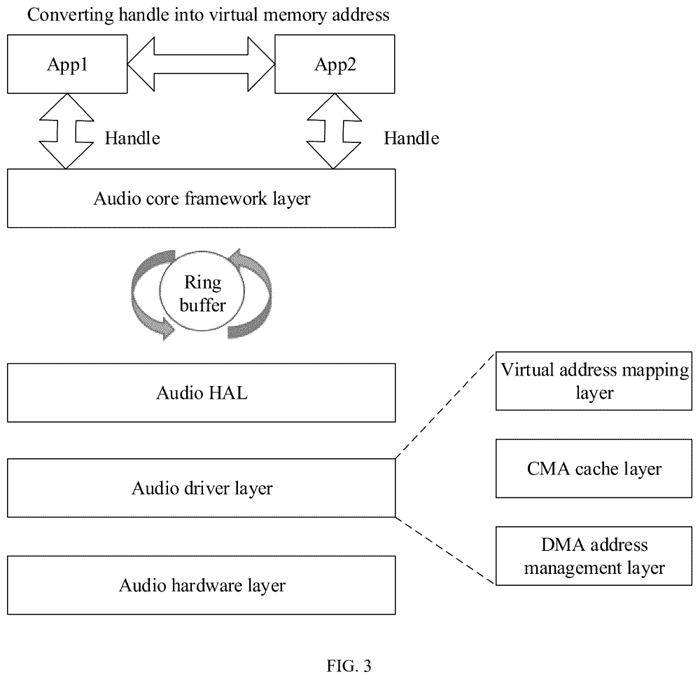

As shown in FIG. 3, an audio processing framework is provided in this embodiment, which includes an audio hardware layer, an audio driver layer, an audio hardware abstraction layer and an audio core framework layer. The audio driver layer includes a DMA address management layer, a CMA cache layer and a virtual address mapping layer. The audio driver layer in this embodiment can use a DMA mechanism of the DMA address management layer to store the target audio data from hardware registers to the physical memory, use CMA technology of the CMA cache layer to allocate continuous physical memories for the target audio data, map the physical memory to virtual memories of the different applications, and use the virtual address mapping layer to map the virtual memory addresses of the different applications into a handle, that is, to determine the handle corresponding to the target audio data, and the handle is transmitted in different applications or different processes, so that each application or process converts the handle into a virtual memory address in the application or process, so as to obtain the target audio data.

The audio processing framework further includes a ring buffer for caching the audio data (the target audio data). A memory structure in the ring buffer is annular with a head pointer and a tail pointer, and consists of N virtual memory block. In this embodiment, each memory block (corresponding to a virtual memory address) is mapped to a handle which is provided to an application of the application layer, so that the handle can be transferred between different processes and between different Apps, and each process acquires the handle and converts the handle into a virtual memory pointer (virtual memory address), thus obtaining all of audio data in the ring buffer.

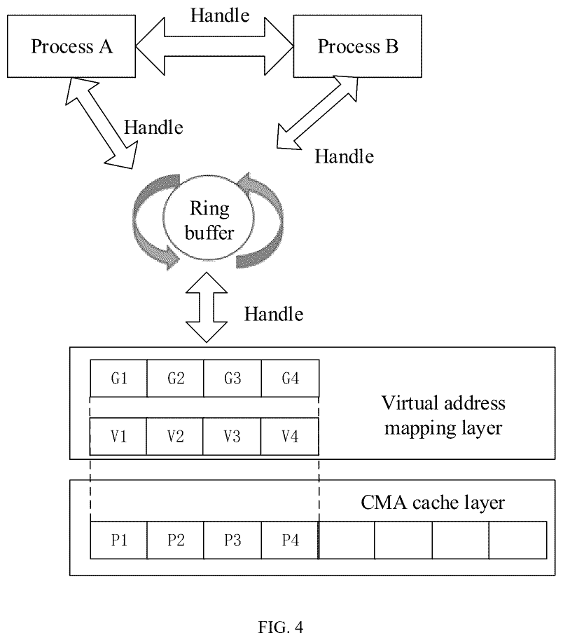

As shown in FIG. 4, an architecture diagram for sharing audio data between different processes is provided in the present disclosure, which includes a CMA cache layer, a virtual address mapping layer, a ring buffer, a process A and a process B. Continuous physical memories such as P1 to P4 are allocated for the target audio data and physical memories P1 to P4 are mapped to virtual memories V1 to V4 by using CMA technology of the CMA cache layer; the virtual memory addresses (V1 to V4) are mapped to handles respectively, that is, the handles (G1 to G4) corresponding to the target audio data are determined, in which V1 is mapped to G1, V2 is mapped to G2, V3 is mapped to G3 and V4 is mapped to G4, and the handles (G1 to G4) are transferred between different applications or different processes, so that different applications or different processes can convert the handles (G1 to G4) into the virtual memory addresses (V1 to V4), thus obtain the target audio data, namely target audio data in PI to P4. The ring buffer stores the target audio data, and each memory block in the ring buffer has a virtual memory address. V1 to V4 in the ring buffer are mapped into the handles (G1 to G4), and each process converts the handles into the virtual memory addresses, thus obtaining all of the data in the ring buffer.

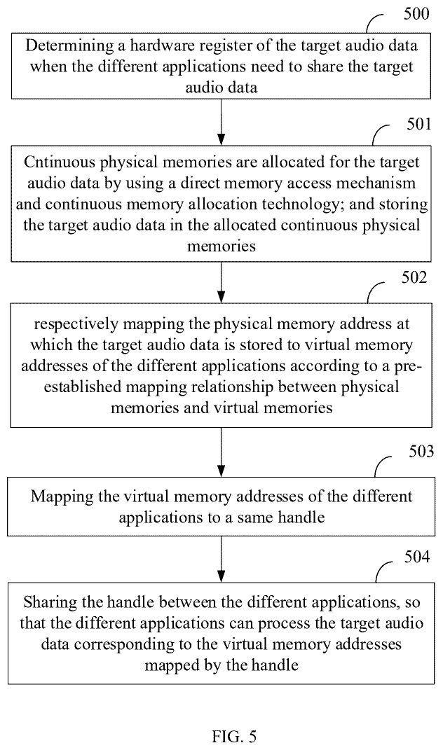

As shown in FIG. 5, an implementation flow of a method for audio data sharing is provided in this embodiment, which is specifically as follows.

In Step 500, a hardware register of the target audio data is determined when the different applications need to share the target audio data.

In Step 501, continuous physical memories are allocated for the target audio data by using a direct memory access mechanism and continuous memory allocation technology; and the target audio data is stored in the allocated continuous physical memories.

In Step 502, the physical memory address at which the target audio data is stored is respectively mapped to virtual memory addresses of the different applications according to a pre-established mapping relationship between physical memories and virtual memories.

In Step 503, the virtual memory addresses of the different applications are mapped to a same handle.

In Step 504, the handle is shared between the different applications, so that the different applications can process the target audio data corresponding to the virtual memory addresses mapped by the handle.

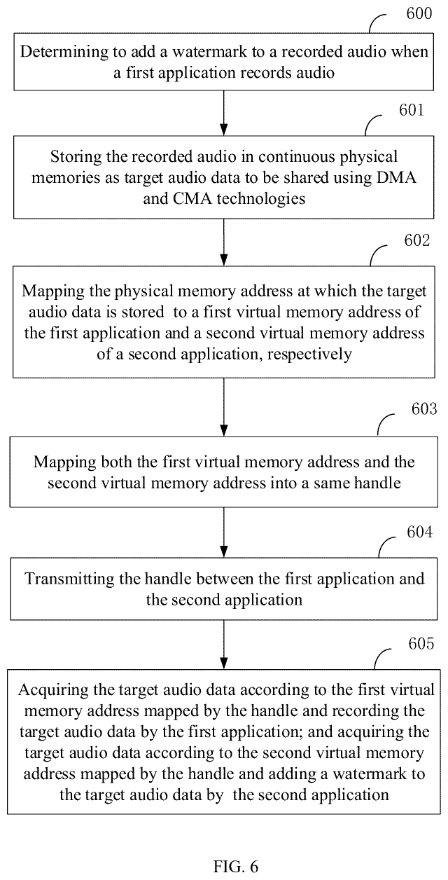

As shown in FIG. 6, a method for audio data sharing for watermarking and recording is provided in this embodiment, and an implementation flow of this method is as follows.

In Step 600, it is determined to add a watermark to a recorded audio when a first application records audio.

In Step 601, the recorded audio is stored in continuous physical memories as target audio data to be shared using DMA and CMA technologies.

In Step 602, the physical memory address at which the target audio data is stored is mapped to a first virtual memory address of the first application and a second virtual memory address of a second application, respectively.

In Step 603, both the first virtual memory address and the second virtual memory address are mapped into a same handle.

In Step 604, the handle is transmitted between the first application and the second application.

In Step 605: the first application acquires the target audio data according to the first virtual memory address mapped by the handle and records the target audio data; and the second application acquires the target audio data according to the second virtual memory address mapped by the handle and adds a watermark to the target audio data.

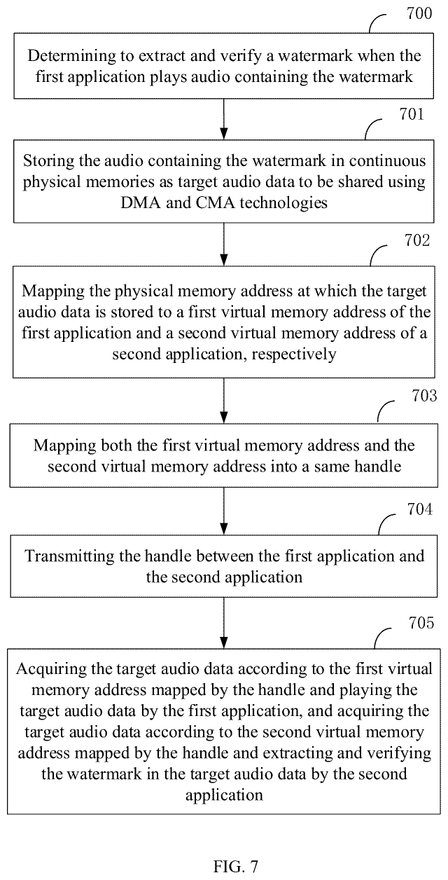

As shown in FIG. 7, a method for audio data sharing for playing and verifying watermark is provided in this embodiment, and an implementation flow of this method is as follows.

In Step 700, it is determined to extract and verify a watermark when the first application plays audio containing the watermark.

In Step 701, the audio containing the watermark is stored in continuous physical memories as target audio data to be shared using DMA and CMA technologies.

In Step 702, the physical memory address at which the target audio data is stored is mapped to a first virtual memory address of the first application and a second virtual memory address of a second application, respectively.

In Step 703, both the first virtual memory address and the second virtual memory address are mapped into a same handle.

In Step 704, the handle is transmitted between the first application and the second application.

In Step 705: the first application acquires the target audio data according to the first virtual memory address mapped by the handle and plays the target audio data, and the second application acquires the target audio data according to the second virtual memory address mapped by the handle and extracts and verifies the watermark in the target audio data.

The method for audio data sharing according to this embodiment realizes mutual accessing among the plurality of applications and processes without copying the audio data, effectively solving problems of audio playing delay, lagging and the like, and further effectively reducing a risk of audio data errors in a copying process, so that efficiency of positioning a problem can be improved due to no copying of the audio data.

Embodiment 2. Based on a same inventive concept, a system for data sharing is further provided in the embodiment of the present disclosure. Since this system is the system in the method according to the embodiment of the present disclosure, and a principle of this system to solve problems is similar to that of the method, implementation of the system can refer to the implementation of the method, which is not repeatedly described in detail herein.

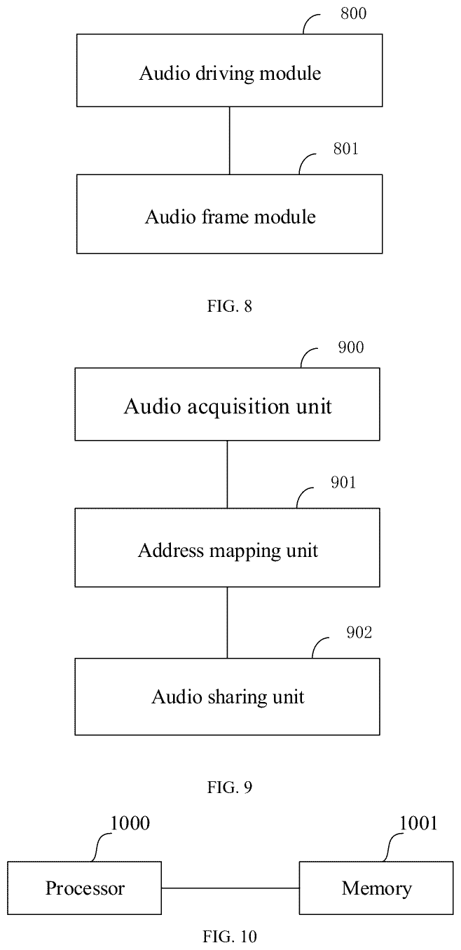

As shown in FIG. 8, a system for data sharing is further provided in the embodiment of the present disclosure, which includes an audio driving module 800 and an audio frame module 801.

The audio driving module 800 is configured to acquire target audio data to be shared between different applications and store the target audio data in a memory; and determine a file descriptor corresponding to the target audio data according to a memory address at which the target audio data is stored.

The audio frame module 801 is configured to share the file descriptor between the different applications, so that the different applications acquire the target audio data according to the memory address corresponding to the file descriptor.

As an alternative implementation, the audio driving module 800 is specifically configured for:
determining a hardware register of the target audio data when the different applications need to share the target audio data; and
acquiring the target audio data from the hardware register and storing the target audio data in the memory.

As an alternative implementation, the audio driving module 800 is specifically configured for:
storing the target audio data in the hardware register in the physical memory by using a direct memory access mechanism.

As an alternative implementation, the audio driving module 800 is specifically configured for:
allocating continuous physical memories for the target audio data by using continuous memory allocation technology; and
storing the target audio data in the allocated continuous physical memories.

As an alternative implementation, the different applications include a first application and a second application. The first application is configured for recording audio, and the second application is configured for adding a watermark to the audio.

The audio driving module 800 is specifically configured for:
acquiring recorded audio through the first application and storing the recorded audio in a hardware register; and
taking the recorded audio as the target audio data to be shared between the first application and the second application, and storing the recorded audio stored in the hardware register in the physical memory.

As an alternative implementation, the different applications include a third application and a fourth application. The third application is configured for playing audio containing a watermark, and the fourth application is configured for verifying the watermark in the audio containing the watermark.

The audio driving module 800 is specifically configured for:
storing the played audio containing the watermark in the physical memory as target audio data to be shared if it is determined that the fourth application is used to verify the watermark when the third application plays the audio containing the watermark.

The audio driving module 800 is specifically further configured for:
transferring the audio containing the watermark from the physical memory to a hardware register, so that an audio hardware reads the audio containing the watermark from the hardware register and play the audio containing the watermark.

As an alternative implementation, the target audio data is stored in the physical memory.

The audio driving module 800 is specifically configured for:
respectively mapping the physical memory address at which the target audio data is stored to virtual memory addresses of the different applications, the virtual memory addresses being isolated from each other between the different applications; and
establishing a mapping relationship between the virtual memory addresses of the different applications and a same file descriptor, and determining the file descriptor corresponding to the target audio data according to the mapping relationship.

As an alternative implementation, the audio driving module 800 is specifically configured for:
by using a kernel of an operating system, mapping the physical memory address at which the target audio data is stored to the virtual memory addresses of the different applications, establishing the mapping relationship between the virtual memory addresses of the different applications and the same file descriptor, and determining the file descriptor corresponding to the target audio data according to the mapping relationship.

As an alternative implementation, the audio driving module 800 is specifically configured for:
establishing the mapping relationship between the virtual memory addresses of the different applications and the same handle, and determining a handle corresponding to the target audio data according to the mapping relationship.

As an alternative implementation, the audio frame module 801 is specifically configured for:
mapping the virtual memory addresses of the different applications to a same handle, and sharing the handle between the different applications, so that the different applications process the target audio data corresponding to the virtual memory addresses mapped by the handle.

As an alternative implementation, the target audio data to be shared includes target audio data processed by the different applications at the same time.

As an alternative implementation, the different applications include different applications running on an Android system.

As an alternative implementation, the audio frame module 801 is specifically configured for:
transmitting the file descriptor to the different applications using an audio framework, so that the file descriptor is shared between the different applications.

As an alternative implementation, the system further includes a delay processing module being specifically configured for:
acquiring the target audio data according to the memory address corresponding to the file descriptor and processing the target audio data by the different applications; and
the processing the target audio data includes:
providing a time delay in processing of the target audio data by the different applications.

Embodiment 3. Based on a same inventive concept, a device for data sharing is further provided in the embodiment of the present disclosure. Since this device is the device in the method according to the embodiment of the present disclosure, and a principle of this device to solve problems is similar to that of the method, implementation of the device can refer to the implementation of the method, which is not repeatedly described in detail herein.

As shown in FIG. 9, the device includes:
an audio acquisition unit 900 configured to acquire target audio data to be shared between different applications and store the target audio data in a memory;
an address mapping unit 901 configured to determine a file descriptor corresponding to the target audio data according to a memory address at which the target audio data is stored; and
an audio sharing unit 902 configured to share the file descriptor between the different applications, so that the different applications acquire the target audio data according to the memory address corresponding to the file descriptor.

As an alternative implementation, the audio acquisition unit 900 is specifically configured for:
determining a hardware register of the target audio data when the different applications need to share the target audio data; and
acquiring the target audio data from the hardware register and storing the target audio data in the memory.

As an alternative implementation, the audio acquisition unit 900 is specifically configured for:
storing the target audio data in the hardware register in the physical memory by using a direct memory access mechanism.

As an alternative implementation, the audio acquisition unit 900 is specifically configured for:
allocating continuous physical memories for the target audio data by using continuous memory allocation technology; and
storing the target audio data in the allocated continuous physical memories.

As an alternative implementation, the different applications include a first application and a second application. The first application is configured for recording audio, and the second application is configured for adding a watermark to the audio.

The audio acquisition unit 900 is specifically configured for:
acquiring recorded audio through the first application and storing the recorded audio in a hardware register; and
taking the recorded audio as the target audio data to be shared between the first application and the second application, and storing the recorded audio stored in the hardware register in the physical memory.

As an alternative implementation, the different applications include a third application and a fourth application. The third application is configured for playing audio containing a watermark, and the fourth application is configured for verifying the watermark in the audio containing the watermark.

The audio acquisition unit 900 is specifically configured for:
storing the played audio containing the watermark in the physical memory as target audio data to be shared if it is determined that the fourth application is used to verify the watermark when the third application plays the audio containing the watermark; and further includes a transferring unit, which is specifically configured for:
transferring the audio containing the watermark from the physical memory to a hardware register, so that an audio hardware reads the audio containing the watermark from the hardware register and play the audio containing the watermark.

As an alternative implementation, the target audio data is stored in the physical memory. The address mapping unit 901 is specifically configured for:
respectively mapping the physical memory address at which the target audio data is stored to virtual memory addresses of the different applications, the virtual memory addresses being isolated from each other between the different applications; and establishing a mapping relationship between the virtual memory addresses of the
different applications and a same file descriptor, and determining the file descriptor corresponding to the target audio data according to the mapping relationship.

As an optional embodiment, the address mapping unit 901 is specifically configured for:
by using a kernel of an operating system, mapping the physical memory address at

which the target audio data is stored to the virtual memory addresses of the different applications, establishing the mapping relationship between the virtual memory addresses of the different applications and the same file descriptor, and determining the file descriptor corresponding to the target audio data according to the mapping relationship.

As an optional embodiment, the address mapping unit 901 is specifically configured for:
establishing the mapping relationship between the virtual memory addresses of the different applications and the same handle, and determining a handle corresponding to the target audio data according to the mapping relationship.

As an optional embodiment, the audio sharing unit 902 is specifically configured for:
mapping the virtual memory addresses of the different applications to a same handle, and sharing the handle between the different applications, so that the different applications process the target audio data corresponding to the virtual memory addresses mapped by the handle.

As an alternative implementation, the target audio data to be shared includes target audio data processed by the different applications at the same time.

As an alternative implementation, the different applications include different applications running on an Android system.

As an optional embodiment, the audio sharing unit 902 is specifically configured for:
transmitting the file descriptor to the different applications using an audio framework, so that the file descriptor is shared between the different applications.

As an optional embodiment, the device further includes a delay processing unit, which is specifically configured for:
acquiring the target audio data according to the memory address corresponding to the file descriptor, and processing the target audio data by the different applications; and
the delay processing unit being specifically configured for:
providing a time delay in processing of the target audio data by the different applications.

Embodiment 4. Based on a same inventive concept, an apparatus for data sharing is further provided in the embodiment of the present disclosure. Since this apparatus is the apparatus in the method according to the embodiment of the present disclosure, and a principle of this apparatus to solve problems is similar to that of the method, implementation of the apparatus can refer to the implementation of the method, which is not repeatedly described in detail herein.

As shown in FIG. 10, the apparatus includes a processor 1000 and a memory 1001. The memory 1001 is configured for storing programs executable by the processor 1000, and the processor 1000 is configured for reading the programs in the memory 1001 and executing following steps:
acquiring target audio data to be shared between different applications and storing the target audio data in a memory;
determining a file descriptor corresponding to the target audio data according to a memory address at which the target audio data is stored; and
sharing the file descriptor between the different applications, so that the different applications acquire the target audio data according to the memory address corresponding to the file descriptor.

As an alternative implementation, the processor 1000 is specifically configured for:
determining a hardware register of the target audio data when the different applications need to share the target audio data; and
acquiring the target audio data from the hardware register and storing the target audio data in the memory.

As an alternative implementation, the processor 1000 is specifically configured for:
storing the target audio data in the hardware register in the physical memory by using a direct memory access mechanism.

As an alternative implementation, the processor 1000 is specifically configured for:
allocating continuous physical memories for the target audio data by using continuous memory allocation technology; and
storing the target audio data in the allocated continuous physical memories.

As an alternative implementation, the different applications include a first application and a second application. The first application is configured for recording audio, and the second application is configured for adding a watermark to the audio.

The processor 1000 is specifically configured for:
acquiring recorded audio through the first application and storing the recorded audio in a hardware register; and
taking the recorded audio as the target audio data to be shared between the first application and the second application, and storing the recorded audio stored in the hardware register in the physical memory.

As an alternative implementation, the different applications include a third application and a fourth application. The third application is configured for playing audio containing a watermark, and the fourth application is configured for verifying the watermark in the audio containing the watermark.

The processor 1000 is specifically configured for:
storing the played audio containing the watermark in the physical memory as target audio data to be shared if it is determined that the fourth application is used to verify the watermark when the third application plays the audio containing the watermark; and

The processor 1000 is specifically further configured for:
transferring the audio containing the watermark from the physical memory to a hardware register, so that an audio hardware reads the audio containing the watermark from the hardware register and play the audio containing the watermark.

As an alternative implementation, the target audio data is stored in the physical memory.

The processor 1000 is specifically configured for:
respectively mapping the physical memory address at which the target audio data is stored to virtual memory addresses of the different applications, the virtual memory addresses being isolated from each other between the different applications; and
establishing a mapping relationship between the virtual memory addresses of the different applications and a same file descriptor, and determining the file descriptor corresponding to the target audio data according to the mapping relationship.

As an alternative implementation, the processor 1000 is specifically configured for:
by using a kernel of an operating system, mapping the physical memory address at which the target audio data is stored to the virtual memory addresses of the different applications, establishing the mapping relationship between the virtual memory addresses of the different applications and the same file descriptor, and determining the file descriptor corresponding to the target audio data according to the mapping relationship.

As an alternative implementation, the processor 1000 is specifically configured for:
establishing the mapping relationship between the virtual memory addresses of the different applications and the same handle, and determining a handle corresponding to the target audio data according to the mapping relationship.

As an alternative implementation, the processor 1000 is specifically configured for:
mapping the virtual memory addresses of the different applications to a same handle, and sharing the handle between the different applications, so that the different applications process the target audio data corresponding to the virtual memory addresses mapped by the handle.

As an alternative implementation, the target audio data to be shared includes target audio data processed by the different applications at the same time.

As an alternative implementation, the different applications include different applications running on an Android system.

As an alternative implementation, the processor 1000 is specifically configured for:
transmitting the file descriptor to the different applications using an audio framework, so that the file descriptor is shared between the different applications.

As an alternative implementation, the processor 1000 is specifically further configured for:
acquiring the target audio data according to the memory address corresponding to the file descriptor and processing the target audio data by the different applications; and

The processor is specifically configured for:
providing a time delay in processing of the target audio data by the different applications.

Based on a same inventive concept, a computer storage medium is further provided in an embodiment of the present disclosure, on which a computer program is stored, which, when executed by a processor, realizes following steps:
acquiring target audio data to be shared between different applications and storing the target audio data in a memory;
determining a file descriptor corresponding to the target audio data according to a memory address at which the target audio data is stored; and
sharing the file descriptor between the different applications, so that the different applications acquire the target audio data according to the memory address corresponding to the file descriptor.

Persons skilled in the art should understand that the embodiments of the present disclosure may be provided as methods, systems, or computer program products. Therefore, the present disclosure may take the form of complete hardware embodiments, complete software embodiments, or embodiments combining software and hardware aspects. Moreover, the present disclosure may take the form of a computer program product implemented on one or more computer available storage media (including but not limited to disk storage and optical storage, etc.) containing computer available program code.

The present disclosure is described with reference to the flow chart and/or block diagram of the method, device (system), and computer program product according to the embodiments of the present disclosure. It should be understood that each process and/or block in the flow chart and/or block diagram can be implemented by computer program instructions, as well as the combination of processes and/or blocks in the flow chart and/or block diagram. These computer program instructions can be provided to processors of general-purpose computers, specialized computers, embedded processors, or other programmable data processing devices to generate a machine that generates instructions executed by processors of computers or other programmable data processing devices to implement the functions specified in one or more processes and/or blocks in a flowchart.

These computer program instructions can also be stored in a computer-readable memory that can guide computers or other programmable data processing devices to work in a specific way, so that the instructions stored in the computer-readable memory generate a manufacturing product including the instruction device, which implements the functions specified in one or more processes and/or blocks of a flow chart.

These computer program instructions can also be loaded onto computers or other programmable data processing devices to perform a series of operational steps on the computer or other programmable devices to generate computer-implemented processing. The instructions executed on the computer or other programmable devices provide steps for implementing the functions specified in one or more processes and/or blocks in a flow chart.

Obviously, persons skilled in the art can make various modifications and variations to the present disclosure without departing from the spirit and scope of the present disclosure. In this way, if the modifications and variations disclosed herein fall within the scope of the claims and their equivalent technologies, the present disclosure also intends to include these modifications and variations.

1. A method for data sharing, comprising:
acquiring target audio data to be shared between different applications and storing the target audio data in a memory;
determining a file descriptor corresponding to the target audio data according to a memory address at which the target audio data is stored; and
sharing the file descriptor between the different applications, so that the different applications acquire the target audio data according to the memory address corresponding to the file descriptor.

2. The method according to claim 1, wherein the acquiring the target audio data to be shared between the different applications and storing the target audio data in the memory comprises:
determining a hardware register of the target audio data when the different applications need to share the target audio data; and
acquiring the target audio data from the hardware register and storing the target audio data in the memory.

3. The method according to claim 2, wherein the acquiring the target audio data from the hardware register and storing the target audio data in the memory comprises:
storing the target audio data in the hardware register in a physical memory by using a direct memory access mechanism.

4. The method according to claim 23, wherein the storing the target audio data in the hardware register in the physical memory comprises:
allocating continuous physical memories for the target audio data by using continuous memory allocation technology; and
storing the target audio data in the allocated continuous physical memories.

5. The method according to claim 1, wherein the different applications comprises a first application and a second application, the first application is configured for recording audio, and the second application is configured for adding a watermark to the audio;
the acquiring the target audio data to be shared between the different applications and storing the target audio data in the memory comprises:
acquiring recorded audio by the first application and storing the recorded audio in a hardware register; and
taking the recorded audio as the target audio data to be shared between the first application and the second application, and storing the recorded audio stored in the hardware register in a physical memory.

6. The method according to claim 1, wherein the different applications comprises a third application and a fourth application, the third application is configured for playing audio containing a watermark, and the fourth application is configured for verifying the watermark in the audio containing the watermark; and
the acquiring the target audio data to be shared between the different applications and storing the target audio data in the memory comprises:
storing the played audio containing the watermark as the target audio data to be shared in a physical memory if it is determined that the fourth application is used to verify the watermark when the third application plays the audio containing the watermark; and
the method further comprises:
transferring the audio containing the watermark from the physical memory to a hardware register, so that an audio hardware reads the audio containing the watermark from the hardware register and plays the audio containing the watermark.

7. The method according to claim 1, wherein the target audio data is stored in a physical memory;
the determining the file descriptor corresponding to the target audio data according to the memory address at which the target audio data is stored comprises:
respectively mapping a physical memory address at which the target audio data is stored to virtual memory addresses of the different applications, wherein the virtual memory addresses are isolated from each other between the different applications; and
establishing a mapping relationship between the virtual memory addresses of the different applications and a same file descriptor, and determining the file descriptor corresponding to the target audio data according to the mapping relationship.

8. The method according to claim 7, wherein the determining the file descriptor corresponding to the target audio data according to the memory address at which the target audio data is stored comprises:
by using a kernel of an operating system, mapping the physical memory address at which the target audio data is stored to the virtual memory addresses of the different applications, establishing the mapping relationship between the virtual memory addresses of the different applications and the same file descriptor, and determining the file descriptor corresponding to the target audio data according to the mapping relationship.

9. The method according to claim 7, wherein the establishing the mapping relationship between the virtual memory addresses of the different applications and the same file descriptor, and determining the file descriptor corresponding to the target audio data according to the mapping relationship comprises:
establishing the mapping relationship between the virtual memory addresses of the different applications and a same handle, and determining a handle corresponding to the target audio data according to the mapping relationship.

10. The method according to claim 9, wherein the sharing the file descriptor between the different applications comprises:
mapping the virtual memory addresses of the different applications to the same handle, and sharing the handle between the different applications, so that the different applications process the target audio data corresponding to the virtual memory addresses mapped by the handle.

11. The method according to claim 1, wherein the target audio data to be shared comprises target audio data processed by the different applications at the same time.

12. The method according to claim 1, wherein the different applications comprise different applications running on an Android system.

13. The method according to claim 1, wherein the sharing the file descriptor between the different applications comprises:
transmitting the file descriptor to the different applications using an audio framework, so that the file descriptor is shared between the different applications.

14. The method according to claim 1, wherein the method further comprises:
by the different applications, acquiring the target audio data according to the memory address corresponding to the file descriptor, and processing the target audio data; and
the processing the target audio data comprises:
providing a time delay in processing of the target audio data by the different applications.

15. A system for data sharing, comprising an audio driving module and an audio frame module, wherein
the audio driving module is configured to acquire target audio data to be shared between different applications and store the target audio data in a memory; and determine a file descriptor corresponding to the target audio data according to a memory address at which the target audio data is stored; and
the audio frame module is configured to share the file descriptor between the different applications, so that the different applications acquire the target audio data according to the memory address corresponding to the file descriptor.

16. An apparatus for data sharing, wherein the apparatus comprises a processor and a memory, wherein the memory is configured for storing programs executable by the processor, and the processor is configured for reading the programs in the memory and executing steps of the method according to claim 1.

17. A non-transitory_computer storage medium, having a computer program stored thereon, wherein the computer program, when executed by a processor, implements steps of the method according to claim 1.
